(19) United States
(12) Patent Application Publication
(10) Pub. No.: US 2013/0189939 A1
(43) Pub. Date: Jul. 25, 2013

(54) LAYERED BEACON TRANSMISSION AND RECEPTION

(71) Applicant: Huaiyuan Wang, Cary, NC (US)

(72) Inventor: Huaiyuan Wang, Cary, NC (US)

(73) Assignee: HTC CORPORATION, Taoyuan City (TW)

(21) Appl. No.: 13/353,694

(22) Filed: Jan. 19, 2012

(51) Int. Cl. H04B 1/04

(52) U.S. Cl. 455/127.1

(57) ABSTRACT

In one embodiment, a method comprising adjusting a power amplifier to provide a primary beacon at a first power level; adjusting the power amplifier to provide a secondary beacon at a second power level, the second power level less than the first power level; receiving a response signal from a receiving device responsive to the secondary beacon; and determining that the receiving device is within an intended coverage area responsive to receiving the response signal.

### TECHNICAL FIELD

The present disclosure generally relates to communications between transmitting and receiving devices, such as mobile devices.

### BACKGROUND

Over the years, portable handheld devices, such as mobile devices (e.g., smartphones) have become prevalent. Through the use of certain applications residing on a mobile device, a user can acquire a multitude of helpful, real-time information from various networks. For instance, while shopping, a user can access the Internet through his or her mobile phone to determine the closest restaurant. Also, while at the restaurant, for instance, the user may decide he or she would like to see a movie, hence accessing the impending movies and corresponding show times for a nearby theater. Likewise, some vendors may advertise via a user's mobile phone, such as through text messaging by the wireless vendor of upcoming rate or service specials.

### SUMMARY

In one embodiment, a system comprising a first access point comprising an adjustable power amplifier and an antenna; a memory comprising encoding and transmitting logic; and a processor, the processor configured by the encoding and transmitting logic to: cause the first access point to provide a primary beacon at a first power level; cause the first access point to provide a secondary beacon at a second power level, the second power level less than the first power level; receive a response signal from a receiving device responsive to the secondary beacon; and determine that the receiving device is within an intended coverage area responsive to receiving the response signal.

In another embodiment, a mobile device comprising a memory comprising beacon determine logic; and a processor, the processor configured by the beacon determine logic to: receive a primary beacon from a first transmitter, the primary beacon transmitted at a first power level; receive a secondary beacon from the first transmitter, the secondary beacon transmitted at a second power level lower than the first power level; and determine proximity of the first transmitter based on characteristics of the primary and secondary beacons.

In another embodiment, a method implemented by an access point, the method comprising adjusting a power amplifier to provide a primary beacon at a first power level; adjusting the power amplifier to provide a secondary beacon at a second power level, the second power level less than the first power level; receiving a response signal from a receiving device responsive to the secondary beacon; and determining that the receiving device is within an intended coverage area responsive to receiving the response signal.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a block diagram of an example network in which an embodiment of a layered beacon transmission and reception system may be employed.

FIG. 2 is a block diagram that depicts an example embodiment of an access point that implements layered beacon transmission.

FIG. 3 is a block diagram that depicts an example embodiment of a receiving device that determines a closest transmitter that implements layered beacon transmission.

FIG. 4 is a schematic diagram that depicts an example of layered beacon transmission for a single access point.

FIG. 5 is a schematic diagram that depicts an example of layered beacon transmission for plural access points associated with respective plural stores.

FIG. 6 is a flow diagram that depicts an example embodiment of a layered beacon transmission method implemented by an access point.

FIG. 7 is a flow diagram that depicts an example embodiment of a layered beacon receiving method implemented by a mobile device.

### DETAILED DESCRIPTION

Disclosed herein are certain embodiments of an invention that provide layered beacon transmission and reception functionality, which may improve the accuracy of radio transmitter detection by a mobile device. In one embodiment, a radio transmitter (e.g., embodied in an access point, such as a router, server, computing device, base station, cell tower, etc.) provides (e.g., transmits) primary beacons with a maximum allowed power to cover as large an area as possible (e.g., to be detected by more radio receivers, such as embodied in a mobile device). Coupling with the primary beacons, the radio transmitter also provides (e.g., transmits) secondary beacons with reduced power and, therefore, a smaller radius, to help improve the detection accuracy in areas with overlapping primary beacons. For instance, a radio receiver may use the information carried in the primary (or referred to also herein as “first”) and secondary (or referred to also herein as “second”) beacons in conjunction with RSSIs (receive signal strength indicators) of the primary and secondary beacons to determine the closest radio transmitter among plural transmitting transmitters.

Digressing briefly, assume a network environment in, for instance, a commercial strip mall, where shoppers walk along a sidewalk adjacent the store fronts and store owners (and/or their respective employee(s)) seek to attract customers into their premises (e.g., boundaries defined by the perimeter of the store) through communication of general information over a wireless network detected by each individuals respective mobile device. Such general information may include general store information that conveys the nature of the business and types of products sold in the store, among other information. The larger the broadcasting area, the more mobile devices available to receive the broadcast. Though each store owner/employee may desire that the beacons provided from an access point within the store reach mobile devices that are outside the store premise (e.g., to attract more customers into the store), one problem that may arise is that the access point in a given store does not have information about whether the recipient of its beacon (e.g., the mobile device possessed by an individual) is physically inside the store (within the boundaries of the perimeter of the store) when a response is received at the access point from the mobile device. This situation is further exasperated when there are competing stores, each comprising an access point transmitting beacons with overlapping coverage areas among the transmitted beacons. Certain embodiments of layered beacon transmission and reception systems are disclosed herein that address these and/or other shortcomings of conventional systems.

Having summarized various aspects of the present disclosure, reference will now be made in detail to the description of the disclosure as illustrated in the drawings. While the disclosure will be described in connection with these drawings, there is no intent to limit it to the embodiment or embodiments disclosed herein. On the contrary, the intent is to cover all alternatives, modifications and equivalents included within the spirit and scope of the disclosure as defined by the appended claims. For instance, the example network environments disclosed herein are described in the context of proximally-located, individual premises (e.g., buildings or units of buildings in which stores reside, such as retail stores), such as found in a strip mall, but it should be appreciated within the context of the present disclosure that any environment where there is a need to discern the closest location between a mobile device and access point is contemplated to be within the scope of the disclosure, including a single business (e.g., retail or otherwise), one or more residential unit(s) (e.g., single family or multi-family, including plural adjacent or otherwise proximally located units or a single, stand-alone unit). As another example, the network environment may be part of a premise such as a conference center or educational environment with moveable or fixed partitions separating a space or room into plural rooms, and each room or plural rooms having one or more access points.

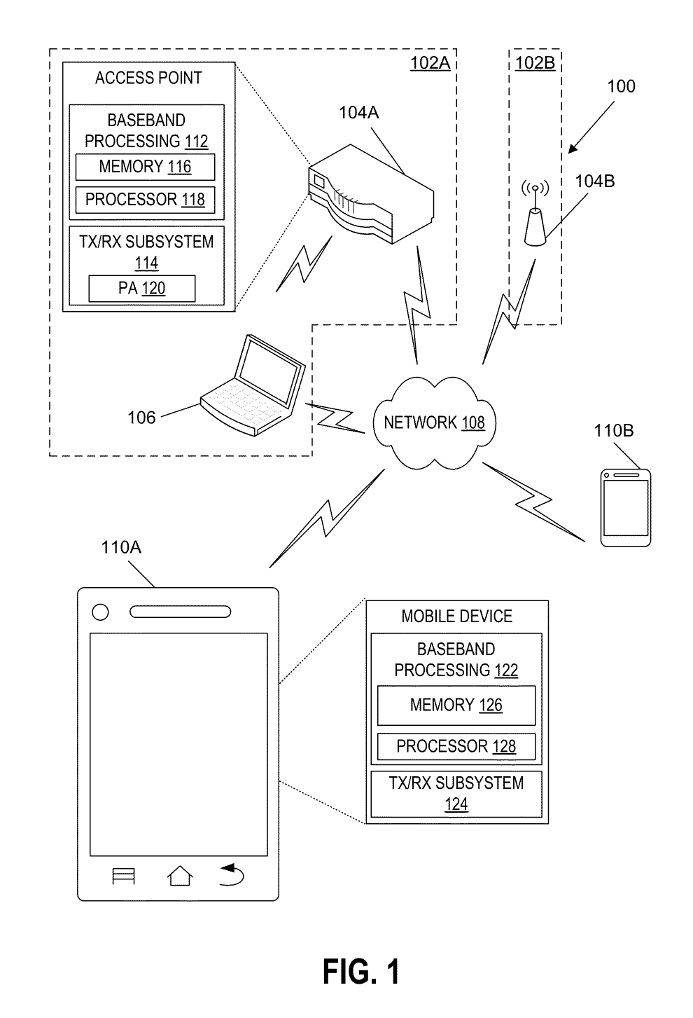

Referring to FIG. 1, shown is an example network 100 in which certain embodiments comprising a layered beacon transmission and reception system may be employed. It should be appreciated by one having ordinary skill in the art that the network 100 depicted in FIG. 1 is merely illustrative, and that other variations with additional networks and/or devices are contemplated to be within the scope of the disclosure. The network 100 may be associated with one or more premises 102A, 102B, in which respective retail stores reside in close enough proximity to each other that at least a primary beacon transmitted from respective access points 104A, 104B (collectively, access point 104) at each premise 102 overlaps. In some embodiments, the access point 104 may be a standalone unit, such as access point 104B, or coupled to a computing device 106, such as access point 104A. The computing device 106 may serve as a user interface to the access point 104A (e.g., shown as a router, without limitation), such as to load information to (and/or interface with information residing in) the access point 104A.

Information includes general store information (e.g., hours, overview of products sold, etc.) and incentive-type information, such as one or more gift offers (e.g., raffle prizes), potential rewards (e.g., registry to a drawing), and/or purchase aids (e.g., coupons, such as e-coupons). Information may also be loaded to the access point 104 remotely (e.g., over a wide area network, such as the Internet), as suggested for access point 1048. In some embodiments, the functionality of the access point 104A and the computing device 106 may be combined into a single apparatus. Though depicted as a router 104A and wireless access point 104B, it should be appreciated that access points may be embodied as a computing device (e.g., laptop 106, workstation or personal computer), base station, cell tower, server, among other devices.

The access points 104 broadcast the general information (e.g., general store information) over the network 108. Note that the general (and/or incentive-type) information may further include performance information of the access point 104, such as channel serviced, capabilities of the access point, RSSI, etc. The network 108 may comprise a local or wide area network, and may comprise more than one network in some embodiments.

Patrons traveling along a walkway adjacent to the premises 102 may carry on their person receiving (or transceiving) devices, such as mobile devices 110A and 1108 (collectively, 110). The mobile devices 110 serve as recipients of the general information, and may be embodied as a cellular phone, smart phone, personal digital assistant, among other mobile communication devices. One or more of the mobile devices 110 may wake up periodically (e.g., from a non-active or sleep mode) in an effort to receive (e.g., capture) transmitted beacons. In some embodiments, one or more of the mobile devices 110 may actively poll (e.g., probe) for nearby transceiver devices. In either case, the mobile devices 110 may receive multiple beacons from multiple access points 104 carrying general information depending on the location of the mobile device 110 relative to the transmitting access points 104. The access points 104 provide the general information at a first power level corresponding to a first coverage area. The first coverage area may encompass the store and areas beyond, such as the walkway or street proximal to the store(s) on which the patrons are traveling (e.g., window shopping).

In addition to the broadcast of a primary beacon carrying general information, the access points 104 transmit (e.g., broadcast) a secondary beacon at a second power level lower than the first power level (and hence having a smaller area of coverage). In one embodiment, the coverage area corresponding to the secondary beacon originates from the access point 104 of the given store and extends to an intended coverage area, such as approximately the boundaries of the associated store, ensuring that only the recipient within the boundaries of the store benefit from special deals or incentives. In other words, the store from which the primary beacon is provided and that carries the general information seeks, in a sense, to garner the attention of a potential patron. One purpose behind the transmittal of the secondary beacon is to reward a patron for actually entering the store by carrying information corresponding to gifts and/or purchasing aids.

Each of the access points, such as access point 104A as depicted in FIG. 1 (with similar applicability to access point 104B), comprises baseband processing logic 112 (e.g., hardware, software, or a combination of both) and a transmit/receive (TX/RX) subsystem 114 (e.g., hardware, software, or a combination of both). The baseband processing logic 112 includes encoding and transmitting logic in memory 116 (e.g., executable code) and a processor 118 that executes the encoding and transmitting logic to cause the primary and secondary beacon transmittals. The TX/RX subsystem 114 comprises known radio electronics, including a power amplifier (PA) 120 that is adjustable (e.g., via signaling from the processor 118 executing the encoding and transmitting logic, which may cause a variation in voltage and/or current to the power amplifier 120). By adjusting the power amplifier 120, the access point 104 is enabled to deliver beacons of different power levels (and different coverage areas).

Similarly, each of the mobile devices, such as mobile device 110A (with similar applicability to mobile device 110B), comprises baseband processing logic 122 (e.g., hardware, software, or a combination of both) and a transmit/receive (TX/RX) subsystem 124 (e.g., hardware, software, or a combination of both). The baseband processing logic 122 comprises beacon determine logic (e.g., executable code) in memory 126 and a processor 128 that executes the beacon determine logic to determine the access point 104 that is closest to the mobile device 110A. The TX/RX subsystem 124 comprises radio electronics to enable acknowledgement or response signaling (e.g., radio frequency (RF)) that is responsive to, for instance, the secondary beacon provided by the access point 104.

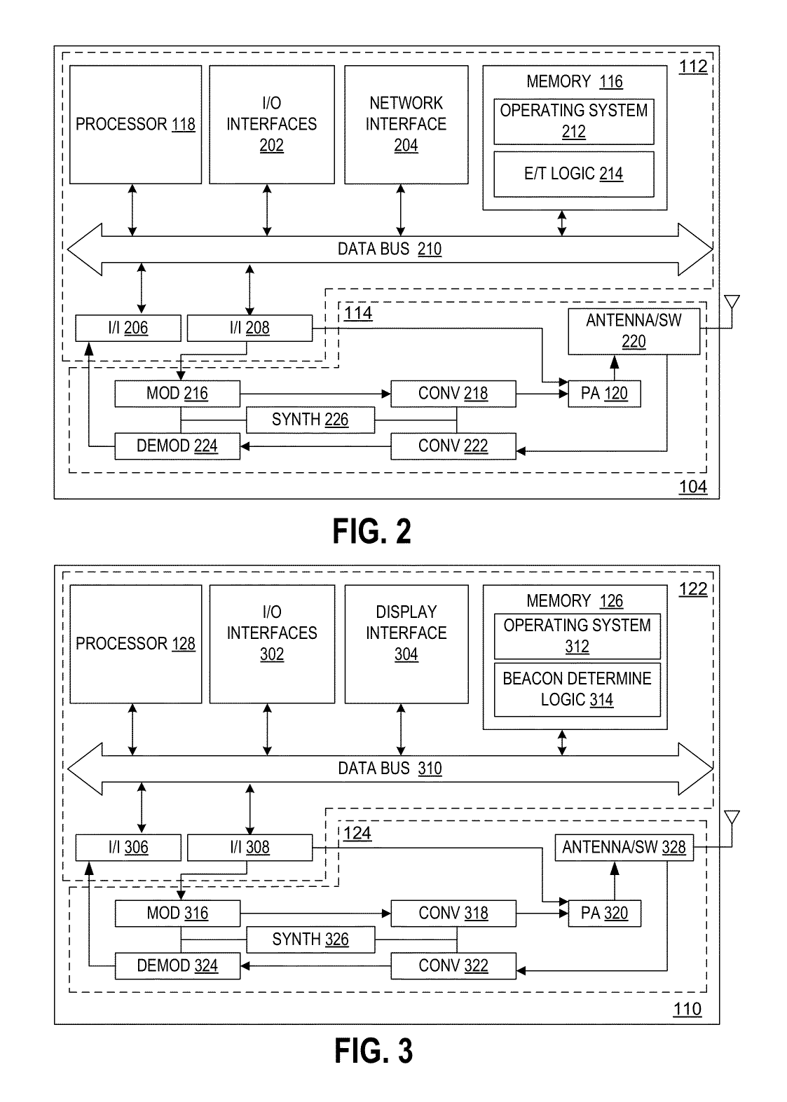

Having described an example environment in which certain embodiments of a layered beacon transmission and reception system may be implemented, attention is directed to FIG. 2, which shows an example architecture for the access point 104. It should be appreciated that the architecture shown in FIG. 2 is merely illustrative, and that variations in architecture with similar or different components to achieve similar functionality (and additional functionality) are contemplated to be within the scope of the disclosure. The access point 104 comprises several components mentioned previously, including the baseband processing logic 112 and the TX/RX subsystem 114. The baseband processing logic 112 comprises the processor 118, input/output (I/O) interfaces 202, a network interface 204, the memory 116, and inter-chip interfaces (I/I) 206 and 208, all coupled to one or more data buses, such as data bus 210. The memory 116 comprises an operating system 212 and encoding and transmitting (E/T) logic 214. Though shown as combined functionality, the encoding and transmitting functionality may be separate logical modules (e.g., software modules) in some embodiments.

The TX/RX subsystem 114 is coupled to the baseband processing logic 112 via the inter-chip interfaces 206 and 208, and comprises components well-known to those having ordinary skill in the art. On the transmit side, the TX/RX subsystem 114 comprises (from signal origin to output) a modulator (MOD) 216 coupled to the inter-chip interface 208, a converter (CONV, such as an upconverter) 218 coupled to the modulator 216, the adjustable power amplifier (PA) 120 coupled to the converter 218, and an antenna/switching (antenna/sw) assembly 220 coupled to the power amplifier 120. Note that although a single antenna is depicted in FIG. 2 (and FIG. 3), plural antennas may be used in some embodiments. On the receiving side, the TX/RX subsystem 114 comprises (from receiving a signal from the network 108, FIG. 1) a converter (CON, such as a downconverter) 222 coupled to the antenna/sw assembly 220, a demodulator (DEMOD) 224 coupled to the converter 222, the former providing an output to the inter-chip interface 206. The TX/RX subsystem 114 further comprises a synthesizer (e.g., phase-locked loop (PLL) assembly) 226 coupled to the modulator 216, demodulator 224, and converters 218 and 222. The PA 120 also receives signaling for adjusting the voltage (and hence power level) via inter-chip interface 208.

The processor 118 may include any custom made or commercially available processor, a central processing unit (CPU) or an auxiliary processor among several processors associated with the access point 104, a semiconductor based microprocessor (in the form of a microchip), a macroprocessor, one or more application specific integrated circuits (ASICs), a plurality of suitably configured digital logic gates, and other well-known electrical configurations comprising discrete elements both individually and in various combinations to coordinate the overall operation of the computing system. In some embodiments, plural processors may be implemented, at least one of which includes a digital signal processor (DSP).

The memory 116 may include any one of a combination of volatile memory elements (e.g., random-access memory (RAM, such as DRAM, and SRAM, etc.)) and nonvolatile memory elements. As indicated above, the memory 116 comprises the operating system 212 and one or more native applications, emulation systems, or emulated applications for any of a variety of operating systems and/or emulated hardware platforms, emulated operating systems, etc. For example, the applications may include application specific software, such as the encoding and transmitting logic 214. The encoding and transmitting logic 214 is executed by the processor 118 and causes the formation and transmittal of a primary beacon at a first power level and a secondary beacon at a second power level different than (e.g., lower) than the first power level. The different power levels of the beacons are derived based on the processor 118 (e.g., executing the encoding and transmitting logic 214) adjusting (e.g., via signaling through inter-chip interface 208) the voltage of the power amplifier 120. One of ordinary skill in the art should appreciate that the memory 116 can, and typically will, comprise other components which have been omitted for purposes of brevity. Further, in some embodiments, one or more of the functionality illustrated in FIG. 2 and described above may be combined in a single component.

In accordance with such embodiments, the software logic is encoded (e.g., stored) in memory 116 and executed by the processor 118. Note that in the context of this disclosure, in general, the memory 116 comprises a non-transitory computer-readable medium that stores programs for use by or in connection with an execution system, apparatus, or device.

The network interface 204 comprises various components (e.g., transceiver logic, drivers, etc.) used to transmit and/or receive data over a wired or wireless, networked environment. The I/O interface 202 is configured to enable communication with local devices, such as the computing device 106.

As noted above, the TX/RX subsystem 114 comprises known components, and hence further discussion of the same is omitted here for brevity. In addition, other radio architectures are contemplated to be within the scope of the disclosure. For instance, though shown with a single-input, single-output (SISO) arrangement, a multiple-input, multiple-output (MIMO) architecture is also contemplated to be within the scope of the disclosure. Further, intermediate or direct conversion architectures may be used. In short, the implementation is independent of the particular PHY layer architecture used.

Having described an embodiment of an access point 104, attention is directed to FIG. 3, which shows an example architecture for an embodiment of a mobile device 110. It should be appreciated that the architecture shown in FIG. 3 is merely illustrative, and that variations in architecture with similar or different components to achieve similar (and/or additional) functionality are contemplated to be within the scope of the disclosure. The mobile device 110 comprises several components mentioned previously, including the baseband processing logic 122 and the TX/RX subsystem 124. The baseband processing logic 122 comprises the processor 128 (e.g., one or more), input/output (I/O) interfaces 302, a display interface 304, the memory 126, inter-chip interfaces 306 and 308, all coupled to one or more data buses, such as data bus 310. The memory 126 comprises an operating system 312 and beacon determine logic 314.

The TX/RX subsystem 124 is coupled to the baseband processing logic 122 via the inter-chip interface 306 and 308, and comprises components well-known to those having ordinary skill in the art. On the transmit side, the TX/RX subsystem 124 comprises (from signal origin to output) a modulator (MOD) 316 coupled to the inter-chip interface 308, a converter (CONV, such as an upconverter) 318 coupled to the modulator 316, a power amplifier (PA) 320 coupled to the converter 318, and an antenna/switching (antenna/sw) assembly 328 coupled to the power amplifier 320. Although a single antenna is shown, plural antennas may be used in some embodiments. On the receiving side, the TX/RX subsystem 124 comprises (from receiving a signal from the network 108, FIG. 1, to the baseband processing logic 122) a converter (CON, such as a downconverter) 322 coupled to the antenna/sw assembly 328, a demodulator (DEMOD) 324 coupled to the converter 322, the former providing an output to the inter-chip interface 306. The TX/RX subsystem 124 further comprises a synthesizer (e.g., phase-locked loop (PLL) assembly) 326 coupled to the modulator 316, demodulator 324, and converters 318 and 322.

The processor 128 may include any custom made or commercially available processor, a central processing unit (CPU) or an auxiliary processor among several processors associated with the mobile device 110, a semiconductor based microprocessor (in the form of a microchip), a macroprocessor, one or more application specific integrated circuits (ASICs), a plurality of suitably configured digital logic gates, and other well-known electrical configurations comprising discrete elements both individually and in various combinations to coordinate the overall operation of the computing system. In some embodiments, plural processors may be implemented, at least one of which includes a digital signal processor (DSP).

The memory 126 may include any one of a combination of volatile memory elements (e.g., random-access memory (RAM, such as DRAM, and SRAM, etc.)) and nonvolatile memory elements. As indicated above, the memory 126 comprises the operating system 312 and one or more native applications, emulation systems, or emulated applications for any of a variety of operating systems and/or emulated hardware platforms, emulated operating systems, etc. For example, the applications may include application specific software, such as the beacon determine logic 314. The beacon determine logic 314 is executed by the processor 128 to use the information carried in the primary and secondary beacons (e.g., RSSIs) to determine the closest access point 104A, 104B. The beacon determine logic 314 may include receive and decode logic, or in some embodiments, receive and decode logic may be implemented as separate software and/or hardware modules. One of ordinary skill in the art should appreciate that the memory 126 can, and typically will, comprise other components which have been omitted for purposes of brevity. As with the access point 104, one or more of the functionality described above and illustrated in FIG. 3 may be combined into a single component.

In accordance with such embodiments, the software logic is encoded (e.g., stored) in memory 126 and executed by the processor 128. Note that in the context of this disclosure, in general, memory 126 comprises a non-transitory computer-readable medium that stores programs for use by or in connection with an execution system, apparatus, or device.

The I/O interface 302 is configured to enable communication with local devices. The display interface 304 is configured to receive input from a user, such as via a display screen, and provides such functionality as on-screen buttons, menus, keyboards, etc. that allows users to navigate objects in the user interfaces by touch.

As noted above, the TX/RX subsystem 124 comprises known components, and hence further discussion of the same is omitted here for brevity. In addition, other radio architectures are contemplated to be within the scope of the disclosure. For instance, though shown with a single-input, single-output (SISO) arrangement, a multiple-input, multiple-output (MIMO) architecture is also contemplated to be within the scope of the disclosure. Further, intermediate or direct conversion architectures may be used. In short, the implementation is independent of the particular PHY layer architecture used.

The encoding and transmitting logic 214 and beacon determine logic 314, or their respective functionality, may be implemented in hardware, software, firmware, or a combination thereof. In the embodiments depicted in FIGS. 2-3, the encoding and transmitting logic 214 and the beacon determine logic 314 are implemented in software or firmware that is stored in memory 116 and 126, respectively, and that are each executed by a suitable instruction execution system. If functionality of the encoding and transmitting logic 214 and/or the beacon determine logic 314 is implemented in hardware, the encoding and transmitting logic and beacon determine logic functionality may be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The encoding and transmitting logic 214 and the beacon determine logic 314, which each may comprise an ordered listing of executable instructions for implementing logical functions, can be embodied in any non-transitory computer-readable medium for use by or in connection with an instruction execution system, apparatus, or device, such as a computer-based system, processor-containing system, or other system that can fetch the instructions from the instruction execution system, apparatus, or device and execute the instructions.

Those skilled in the art should appreciate that the mobile device 110 may include other components or units, known in the art, and not shown for purposes of brevity. For instance, the mobile device 110 may further include built-in camera logic for capturing images or video, or browser logic for accessing the Internet, among other functionality. Further, functionality of one or more components depicted in FIGS. 2-3 may be combined in a single module, or further distributed among additional modules.

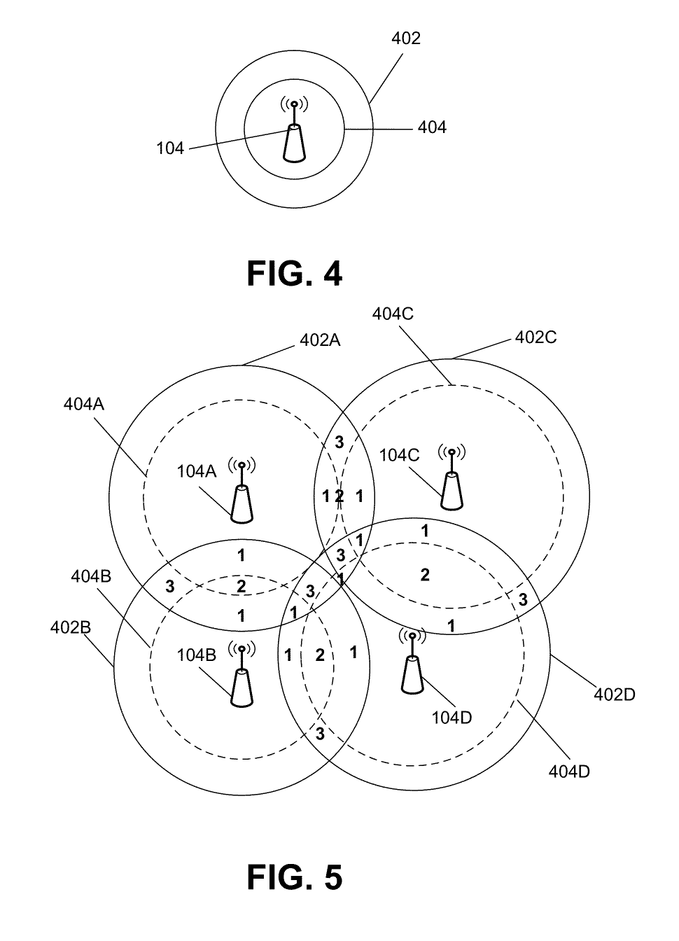

Now directing attention to FIG. 4, shown is an example access point 104 that transmits two beacons of differing power levels (and hence coverage areas), including a primary beacon 402 and a secondary beacon 404. For instance, the access point 104 may be located within a store, and the primary beacon 402 may correspond to a broadcast of general information extending beyond the boundaries of the store. In a single building, those boundaries may be the perimeter of the building in which the store resides. For a strip mall, the boundaries may be the rented or leased space which is occupied by the store. In a conference area or building with plural classrooms, the boundaries may be the perimeter of a given room, such as via moveable walls. Other variations are contemplated. The amount of coverage extension of the primary beacon 402 beyond the boundaries may vary, and may be configurable at the access point 104 (or at a user interface coupled to the access point) by the store owner(s) and/or employee(s).

In one embodiment, the access point 104 transmits the primary beacon 402 according to a maximum allowed transmit power (via adjustment of the power amplifier 120 as described previously) to cover as large an area as possible. In some embodiments, the extent of coverage may be less than the coverage at maximum, as suggested above.

The secondary beacon 404 may correspond to a broadcast of more specific information (e.g., incentive-type information), and comprises a smaller coverage area (via lower power level) than that manifested by the primary beacon 402. In other words, the secondary beacon coverage corresponds in substantial part to the intended coverage area. Hence, the secondary beacon 404 may alert nearby mobile devices 110 with location specific information. The access point 104 transmits the secondary beacon 404 with a reduced transmit power (via adjustment of the power amplifier 120) and hence covers a smaller radius than the primary beacon 402. The transmit power for the secondary beacon 404 may be fixed or variable. For instance, a variable transmit power may be used to randomize the size of the beacon coverage area. A secondary beacon 404 that is detected by the mobile device 110 may trigger subsequent responses/actions by the mobile device 110. For instance, a user of the mobile device 110 may be alerted to respond to offers for special deals. As another example, the mobile device 110, responsive to providing a response signal to the access point 104 (which in turn is responsive to the secondary beacon 404) may automatically be registered by the access point 104 for a raffle or other gifts. These gifts and/or purchasing aids serve to reward the user for entering the store (e.g., and hence within the intended coverage area of the secondary beacon 404). For instance, the store may not allow such raffle registration by the mobile device 110 if the mobile device 110 is not inside the store premise (e.g., not within the intended coverage area).

Transmission of the secondary beacon 404 may be alternated with transmission of the primary beacon 402, or provided in tandem with the primary beacon transmissions. The transmit power of the secondary beacon 404 may be fixed or follow a varying pattern to randomize the radius of the secondary beacon coverage area. In some embodiments, the transmit interval of the secondary beacons 404 may differ from that of the primary beacons 402. As mentioned previously, the secondary beacons 404 may carry different information than the information provided by the primary beacons 402.

Although the case of a single store having two coverage areas associated with beacons 402 and 404 enables the access point 104 to unambiguously determine whether a given mobile device 110 is within the store premises or not, the situation becomes further complicated when there are multiple access points 104 providing competing information. Referring to FIG. 5, shown are access points 104A, 104B, 104C, and 104D located in respective, proximally located store premises (e.g., each adjacent to another in this example, though not required to be adjacent). It should be appreciated that other arrangements of access points with similar or different overlapping coverage are contemplated to be within the scope of the disclosure. In the depicted embodiment, the access point 104A broadcasts a primary beacon 402A and a secondary beacon 404A, the secondary beacon 404A comprising a coverage area that is smaller than the coverage area of the primary beacon 402A. The access point 1048 broadcasts a primary beacon 402B and a secondary beacon 404B, the secondary beacon 404B comprising a coverage area that is smaller than the coverage area of the primary beacon 402B. The access point 104C broadcasts a primary beacon 402C and a secondary beacon 404C, the secondary beacon 404C comprising a coverage area that is smaller than the coverage area of the primary beacon 402C. The access point 104D broadcasts a primary beacon 402D and a secondary beacon 404D, the secondary beacon 404D comprising a coverage area that is smaller than the coverage area of the primary beacon 402D.

A partial overlap in coverage area exists among various combinations of the beacons. For instance, the primary beacon 402A comprises a coverage area that partly overlaps the coverage area of primary beacons 402B, 402C, and 402D. Table 1 below provides a summary of the beacon overlap example shown in FIG. 5. Other variations in coverage are contemplated. An “X” in a given box below signifies overlap (at least in part) between a beacon identified in a given row with a beacon identified in a given column, with “Y” indicating an approximately shared edge of the two identified beacons (also considered an area of transmitter detection ambiguity and hence some overlap). A dash “-” in a given box merely represents the same beacon identity in the row and column, and a “NBO” denotes no beacon overlap. As noted by the “NBO,” previously ambiguous areas of transmitter (e.g., access point) detection (e.g., due to primary beacon overlap) are now areas of unambiguous detection.

TABLE 1

| | 402A | 402B | 402C | 402D | 404A | 404B | 404C | 404D |
|---|---|---|---|---|---|---|---|---|
| 402A | — | X | X | X | X | X | X | X |
| 402B | X | — | Y | X | X | X | NBO | X |
| 402C | X | Y | — | X | X | NBO | X | X |
| 402D | X | X | X | — | NBO | X | X | X |
| 404A | X | X | Y | Y | — | X | Y | NBO |
| 404B | X | X | NBO | X | X | — | NBO | X |
| 404C | Y | NBO | Y | X | Y | NBO | — | X |
| 404D | X | X | X | X | NBO | X | X | — |

As illustrated in FIG. 5, when a mobile device 110 is located at spots within the coverage areas denoted with a “1,” the mobile device 110 at any of those locations is able to unambiguously identify the closest access point 104 based on the secondary beacon 404. As noted in FIG. 5, spots denoted with a “1” are within a single secondary beacon coverage area. For instance, a mobile device 110 at location “1” located in the coverage area of beacon 404A has no overlap with any other secondary beacon 404.

When a mobile device 110 is located at spots within the coverage areas denoted with a “2,” the mobile device 110 utilizes received RSSIs from both the primary 402 and secondary 404 beacons to help improve the accuracy of access point detection (e.g., closest access point 104). For instance, a mobile device 110 at a spot denoted “2” is shown within two secondary beacon coverage areas corresponding to secondary beacons 404B and 404D, and hence computations of the RSSI signals from these overlapping beacon signals 402B, 404B, 402D, and 404D are implemented to determine which of the two access points 1048 and 104D is closest.

When mobile devices 110 are at locations denoted by a “3,” detection (e.g., of the closest access point 104) remains ambiguous (e.g., the mobile device 110 at such a location receives no secondary beacon).

Recapping the description of FIG. 5 above, if the programmed preference of a given mobile device 110 is to connect with the closest access point, that mobile device 110 will have no difficulty locating the access point 104 when the mobile device 110 is located in one of the spots marked designated with a “1.” However, when the mobile device 110 is located at spots denoted by “2”,” the mobile device 110 receives more than one secondary beacon 404, and hence logic in the mobile device (e.g., beacon determine logic 314, as executed by processor 128) determines which access point 104 is the ideal one (e.g., closest) based on relative signal strengths of secondary beacons as well as its preferences. As indicated above, RSSI measurements may be used to help pinpoint the closest access point 104.

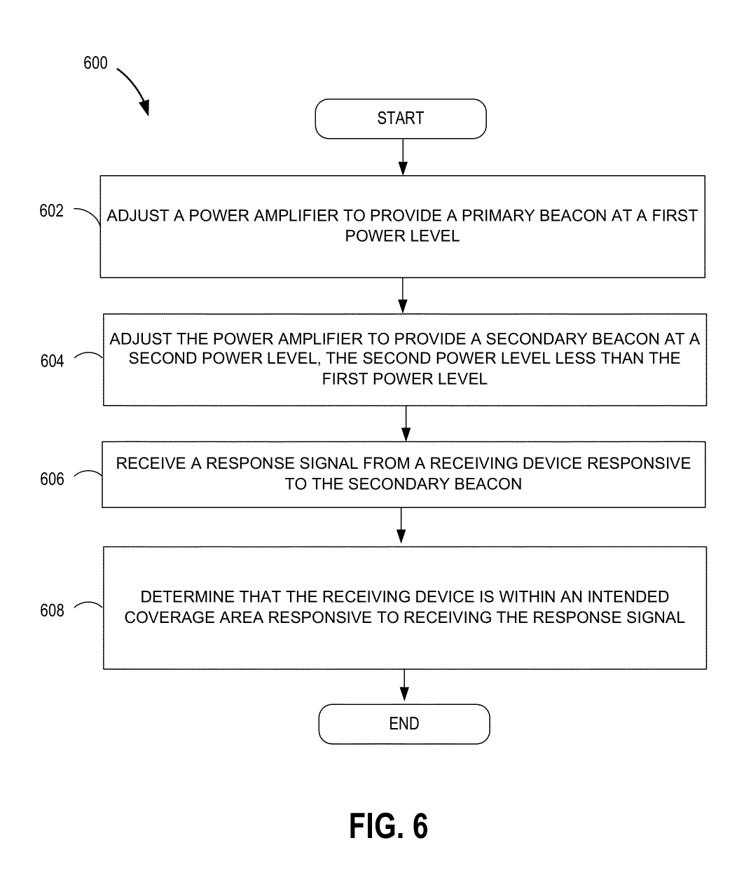

Having described certain embodiments of layered beacon transmission and reception systems, it should be appreciated, in view of the aforementioned description, that one layered beacon transmission method 600, depicted in FIG. 6 and employed by an access point, such as access point 104, comprises adjusting a power amplifier to provide a primary beacon at a first power level (602); adjusting the power amplifier to provide a secondary beacon at a second power level, the second power level less than the first power level (604); receiving a response signal from a receiving device responsive to the secondary beacon (606); and determining that the receiving device is within an intended coverage area responsive to receiving the response signal (608). In one embodiment, the intended coverage area may reside within the boundaries of a premise.

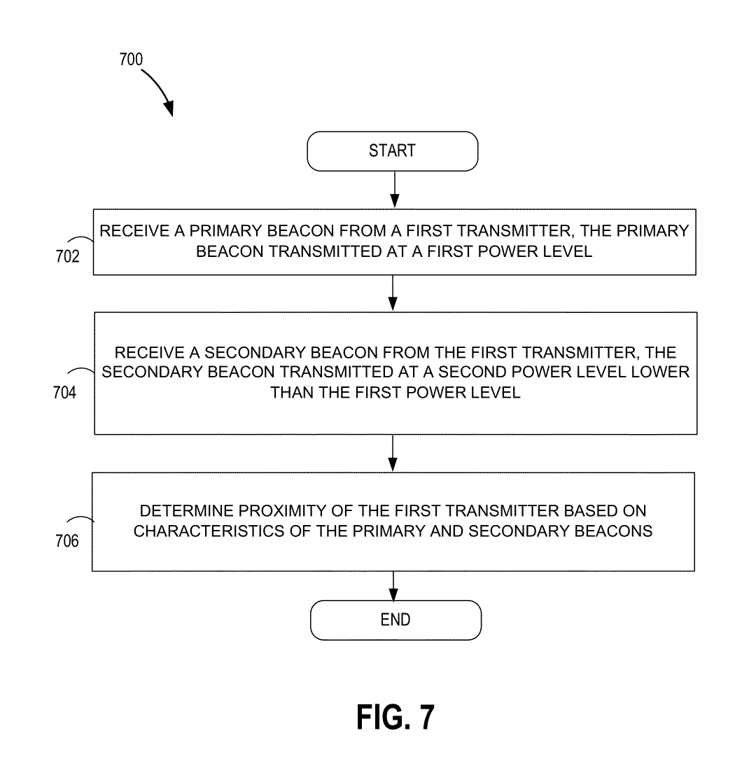

It should be appreciated, in view of the aforementioned description, that one layered beacon receiving method 700, depicted in FIG. 7 and employed by a mobile device, such as mobile device 110, comprises receiving a primary beacon from a first transmitter, the primary beacon transmitted at a first power level (702); receiving a secondary beacon from the first transmitter, the secondary beacon transmitted at a second power level lower than the first power level (704); and determining proximity of the first transmitter based on characteristics (e.g., RSSI information) of the primary and secondary beacons (706).

Although the flow diagrams of FIGS. 6 and 7 show a specific order of execution, it is understood that the order of execution may differ from that which is depicted. Further, the methods described in FIGS. 6 and 7 are not limited to the devices or device architectures described herein.

It should be appreciated that, though certain components of embodiments of layered beacon transmission and reception systems have been depicted as implemented as software, in some embodiments, one or more of the functionality described herein as implemented in software may be implemented in hardware or a combination of software and hardware.

It should be emphasized that the above-described embodiments are merely examples of possible implementations. Many variations and modifications may be made to the above-described embodiments without departing from the principles of the present disclosure. For instance, in some implementations, a row of conference rooms adjacent to each other may each have a presentation display system (e.g., laptop and projection device), and the primary and secondary beacons may be used to enable a presenter to access a given laptop in a given room despite overlap in the primary beacons. Once identified, a laptop may receive, for instance, a user's presentation material. Other applications of the layered beacon transmission and reception systems are contemplated to be within the scope of the disclosure. All such modifications and variations are intended to be included herein within the scope of this disclosure and protected by the following claims.

At least the following is claimed:

1. A system, comprising:
a first access point comprising an adjustable power amplifier and an antenna;
a memory comprising encoding and transmitting logic; and
a processor, the processor configured by the encoding and transmitting logic to:
cause the first access point to provide a primary beacon at a first power level; and
cause the first access point to provide a secondary beacon at a second power level, the second power level less than the first power level;
receive a response signal from a receiving device responsive to the secondary beacon; and
determine that the receiving device is within an intended coverage area responsive to receiving the response signal.

2. The system of claim 1, wherein the processor is further configured by the encoding and transmitting logic to provide second information to the receiving device responsive to the determination.

3. The system of claim 2, wherein the second information comprises one or more gift offers or one or more purchasing aids.

4. The system of claim 1, wherein the second power level is either fixed or variable.

5. The system of claim 1, wherein the primary and secondary beacons are provided by transmitting either alternately or in tandem.

6. The system of claim 5, wherein a transmit interval of the primary beacon is different than a transmit interval of the secondary beacon.

7. The system of claim 1, wherein the processor is further configured by the encoding and transmitting logic to adjust a power level of the amplifier to cause the first power level and the second power level.

8. The system of claim 1, wherein the first power level corresponds to a first coverage area and the second power level corresponds to a second coverage area smaller than the first coverage area.

9. The system of claim 1, wherein the primary and secondary beacons comprises first and second information, respectively, wherein the first information is different than the second information.

10. The system of claim 9, wherein the first information comprises general store information associated with a store residing within a building, the store having a building perimeter at the boundaries of a premise and wherein the second information comprises one or more gift offers or one or more purchasing aids from the store, the second information unavailable in the first information.

11. The system of claim 1, wherein the primary and secondary beacons comprises first and second information, respectively, wherein the first and second information comprise the same or different identifiers.

12. The system of claim 1, further comprising a second access point, wherein the primary and secondary beacon transmissions are coordinated among the first and second access points.

13. The system of claim 1, wherein the intended coverage area substantially corresponds to an area of a premise, the premise comprising either:
a store residing within a building, the store having a building perimeter at the boundaries of the premise;
one of plural adjacent rooms in a building, the plural adjacent rooms comprising one or more access points in each, one of the plural rooms including the first access point; or
one store among plural adjacent stores, each of the plural stores comprising one or more access points, one of the plural stores having the first access point within a perimeter located at the boundaries of the one of the plural stores.

14. A mobile device, comprising:
a memory comprising beacon determine logic; and
a processor, the processor configured by the beacon determine logic to:
receive a primary beacon from a first transmitter, the primary beacon transmitted at a first power level;
receive a secondary beacon from the first transmitter, the secondary beacon transmitted at a second power level lower than the first power level; and
determine proximity of the first transmitter based on characteristics of the primary and secondary beacons.

15. The mobile device of claim 14, wherein the processor is further configured by the beacon determine logic to determine based on a comparison of receive signal strength indicators (RSSI) information in the primary and secondary beacons.

16. The mobile device of claim 14, wherein the received primary and secondary beacons comprise different information.

17. The mobile device of claim 16, wherein the information of the primary beacon comprises general store information from a store within a first coverage area of the primary beacon and the information of the secondary beacon comprises one or more gift offers or one or more purchasing aids from a store that is located inside an intended coverage area of the secondary beacon.

18. The mobile device of claim 14, wherein the second power level is either fixed or variable.

19. The mobile device of claim 14, wherein the primary and secondary beacons are received either alternately or in tandem.

20. The mobile device of claim 14, wherein the first power level corresponds to a first coverage area and the second power level corresponds to a second coverage area smaller than the first coverage area.

21. The mobile device of claim 14, wherein the processor is further configured by the beacon determine logic to:
receive plural beacons from plural transmitters, wherein one of the plural beacons comprises the primary beacon; and
determine which of the plural transmitters is closest based on the plural beacons and the secondary beacon.

22. A method implemented by an access point, the method comprising:
adjusting a power amplifier to provide a primary beacon at a first power level;
adjusting the power amplifier to provide a secondary beacon at a second power level, the second power level less than the first power level;
receiving a response signal from a receiving device responsive to the secondary beacon; and
determining that the receiving device is within an intended coverage area responsive to receiving the response signal.
